(19) United States
(12) Patent Application Publication
(10) Pub. No.: US 2025/0369280 A1
(43) Pub. Date: Dec. 4, 2025

(54) SLIDING BARRICADE DOOR FOR EMERGENCY SECURITY

(71) Applicant: Lockdowntech LLC, St. Charles, MN (US)

(72) Inventors: Ryan William Ihrke, St. Charles, MN (US); Heath Raymond Ihrke, Plainview, MN (US); Corey Michael Kelly, Winona, MN (US)

(21) Appl. No.: 19/222,321

(22) Filed: May 29, 2025

Related U.S. Application Data
(60) Provisional application No. 63/653,001, filed on May 29, 2024.

(51) Int. Cl. E06B 5/10; A47B 63/00; E05C 3/14

(52) U.S. Cl. CPC E06B 5/10; E05C 3/145; A47B 63/00

(57) ABSTRACT

A system of a protective barrier for a room having a support frame coupled to a horizontal rail extending along a top portion of an existing room door, where the horizontal rail has a track. The system includes a sliding door with a door frame with rollers operably coupled with the track. The sliding door further includes an armored back sheet coupled to the door frame and a latch having a catch on a first end configured to operably engage a D-pin to hold the sliding door in a closed position.

### CROSS-REFERENCE TO RELATED APPLICATION(S)

This application claims the benefit under 35 U.S.C. § 119(e) to U.S. Provisional Application 63/653,001, filed Aug. 28, 2024, and entitled “BOOKSHELF/DOOR FOR EMERGENCY SECURITY,” the disclosure of which is hereby incorporated herein in its entirety.

### TECHNICAL FIELD

This disclosure relates to embodiments of safety and security devices, systems, and methods in educational environments, particularly those intended to enhance the security of classrooms against armed threats. In particular, certain such embodiments provide a bulletproof, multi-functional door that serves as a regular bookshelf and can be quickly transformed into a secure barricade in emergencies, enhancing classroom safety without sacrificing aesthetic and functional value.

### BACKGROUND

In the event of a school related emergency like an active shooter situation, individual classrooms need to be locked and/or otherwise inaccessible from the outside to anyone but a select group of school related individuals (e.g., administration and other emergency personnel). The classrooms need to be locked very quickly and easily upon learning of the emergency situation.

Classrooms currently lack effective and quickly deployable security measures in the event of active shooter situations, relying instead on inadequate temporary barricades. Current aftermarket barricading devices completely disable door functioning, impeding emergency personnel from accessing barricaded rooms. Other existing solutions include small furniture pieces and manually held doors, which do not offer substantial or reliable protection.

### SUMMARY

In general, this disclosure relates to systems, devices, and methods for using a classroom door that can be designed to function as both a bulletproof barricade and a usable bookshelf. A sliding mechanism can be included that allows the bookshelf/door to lock into place during emergencies. In some examples, the locking mechanism is operable from both inside the classroom and outside by authorized personnel.

In Example 1, a protective slidable barrier for a room comprises a support frame having a horizontal rail extending along a top portion of an existing room door opening. The horizontal rail includes a track. The barrier has a sliding door with a bulletproof back sheet, a door frame having a plurality of rollers operably coupled with the horizontal rail, and a latch configured to secure the barrier in an open or closed position.

Example 2 relates to the protective slidable barrier of Example 1, wherein in the open position the sliding door is configured to be completely free of the existing room door opening, and in the closed position the sliding door is configured to completely cover the existing room door opening.

Example 3 relates to the protective slidable barrier of Example 1, wherein the sliding door comprises a bookshelf coupled to the door frame on an opposite side from the bulletproof back sheet.

Example 4 relates to the protective slidable barrier of Example 1, wherein the support frame further comprises a pair of vertical uprights, each of the pair of vertical uprights affixed to either side of the existing room door opening and configured to support the horizontal rail.

Example 5 relates to the protective slidable barrier of Example 4, wherein each of the pair of vertical uprights are operably coupled to each of a pair of existing vertical uprights of the existing door room door opening.

Example 6 relates to the protective slidable barrier of Example 1, wherein each of the pair of vertical uprights comprises a catch pin.

Example 7 relates to the protective slidable barrier of Example 1, wherein the latch comprises a rotatable latch configured to operably engage a catch pin to secure the barrier in the closed position.

In Example 8, a protective slidable barrier for a room comprises a frame having a horizontal rail extending along a top portion of an existing room door, the horizontal rail comprising a track, a sliding door comprising a door frame having a plurality of rollers operably coupled with the track, and an armored back sheet coupled to the door frame. The barrier has a locking mechanism comprising a catch pin, a latch, and a catch on one end of the latch and configured to operably engage the catch pin to hold the sliding door in a closed position.

Example 9 relates to the protective slidable barrier of Example 8, wherein the sliding door further comprises an open position, wherein the sliding door is configured to be completely free of the existing room door opening, and wherein the sliding door is configured to completely cover the existing room door opening when in the closed position.

Example 10 relates to the protective slidable barrier of Example 8, wherein the sliding door further comprises a bookshelf coupled to the door frame on an opposite side from the armored back sheet.

Example 11 relates to the protective slidable barrier of Example 8, wherein the support frame further comprises a pair of vertical uprights, each of the pair of vertical uprights affixed to either side of the existing room door opening and configured to support the horizontal rail.

Example 12 relates to the protective slidable barrier of Example 11, wherein each of the pair of vertical uprights are operably coupled to each of a pair of vertical uprights of a door frame of the existing room door opening.

Example 13 relates to the protective slidable barrier of Example 11, wherein the latch comprises a rotatable latch configured to operably engage the catch pin to secure the sliding door in the closed position.

In Example 14, a protective barrier system for a room includes a support frame with a horizontal rail extending along a top portion of an existing room door, where the horizontal rail has a track. The system includes a sliding door with a door frame with rollers operably coupled with the track. The sliding door further includes an armored back sheet coupled to the door frame and a latch having a catch on a first end configured to operably engage a D-pin to hold the sliding door in a closed position.

Example 15 relates to the protective barrier system of Example 14, wherein the support frame further comprises a pair of vertical uprights, each of the pair of vertical uprights affixed to either side of the existing room door opening and configured to support the horizontal rail.

Example 16 relates to the system of a protective barrier of Example 15, wherein the D-pin is disposed on one of the pair of vertical uprights.

Example 17 relates to the system of a protective barrier of Example 14, wherein the rotatable latch further comprises a second catch on a second end configured to operably engage a second D-pin to hold the sliding door in an open position.

Example 18 relates to the system of a protective barrier of Example 14, wherein the armored back sheet comprises a ballistic material.

Example 19 relates to the system of a protective barrier of Example 14, wherein the sliding door further comprises a bookshelf coupled to a front side of the door frame.

Example 20 relates to the system of a protective barrier of Example 14, wherein the support frame is operably coupled to a door frame of the existing room door opening.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

The following drawings are illustrative of particular examples of the present invention and therefore do not limit the scope of invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is an isometric view of a sliding barricade door system of an embodiment of the present disclosure.

FIG. 2 is another isometric view of a sliding barricade door system of an embodiment of the present disclosure.

FIG. 3 is an exploded view of a sliding barricade door system of an embodiment of the present disclosure.

FIG. 4 is a side view of a sliding barricade door system of an embodiment of the present disclosure.

FIG. 5 is a side view of the rollers and rail of a sliding barricade door system of an embodiment of the present disclosure.

FIG. 6 is a closeup view of the handle from the inside of a sliding barricade door system of an embodiment of the present disclosure.

FIG. 7 is a closeup view of the handle area from the outside of a sliding barricade door system of an embodiment of the present disclosure.

FIG. 8 is a rear view of the locking system of a sliding barricade door system of an embodiment of the present disclosure.

FIG. 9 is an isometric view of the locking system of a sliding barricade door system of an embodiment of the present disclosure.

FIG. 10 is an isometric view of the locking system of a sliding barricade door system of another embodiment of the present disclosure.

FIG. 11 is a rear view of the locking system of a sliding barricade door system of another embodiment of the present disclosure.

FIG. 12 is a top view of the locking system of a sliding barricade door system of another embodiment of the present disclosure.

### DETAILED DESCRIPTION

The following detailed description is exemplary in nature and provides practical illustrations and examples. Those skilled in the art will recognize that many of the noted examples have a variety of suitable alternatives. A number of various exemplary emergency security features are disclosed herein using the description provided as follows in addition to the accompanying drawings. Each of the embodiments disclosed herein can be employed independently or in combination with one or more (e.g., all) of the other embodiments disclosed herein.

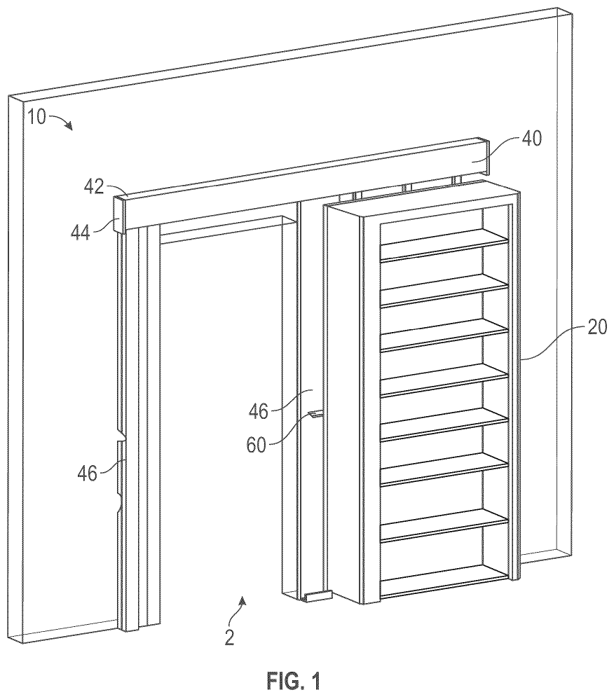

In some examples as best shown in FIG. 1, the system 10 described herein provides a bulletproof (i.e., able to withstand being pierced or penetrated by bullets), multi-functional door 20 that serves as an aesthetically pleasing and/or functional classroom element such as regular bookshelf, a pegboard, and/or whiteboard, and can be quickly transformed into a secure barricade in emergencies, enhancing classroom safety without sacrificing aesthetic and functional value. In such examples, the system 10 includes a door 20, a frame 40, and a locking mechanism 60 that locks the door 20 in place with respect to the frame 40. The door 20 is movable along the frame 40 as described in detail below.

Example systems 10 include an additional door structure in classrooms which functions for most of its lifespan, in one exemplary embodiment, as a bookshelf 20, although it should be known that other embodiments include a whiteboard or other classroom related element(s). The barricade or door 20 may be any size, shape and configuration and may have a bulletproof or armored sheet 32 (e.g., a sheet of ballistic steel, Kevlar, polycarbonate, ceramic, fiberglass, wood, or any other ballistic material known in the art), on a back side. The barricade 20 can quickly slide into place in the event of an emergency in a school, thereby barricading the room from any potential shooter/threat. A problem that this device resolves is the difficulty in barricading a room during an active shooter situation. Often barriers in classrooms during an active shooter event are small pieces of furniture and adults holding the door. The barricade 20 can create a quick, bulletproof barrier between the shooter and those in a classroom. In some embodiments, the barricade 20 is heavy, locks into the frame, and cannot be kicked in or pushed through, as well as functioning as an aesthetically pleasing and functional addition to the classroom environment (e.g., as a bookshelf). In some embodiments, it has a very simple and commonplace disengaging functionality which replicates that of a door-it is able to be opened by small children on the inside of the room while inaccessible from the outside except to emergency responders and other designated leaders via the use of a specially designed “key” that slides into place when disengaging from the hallway.

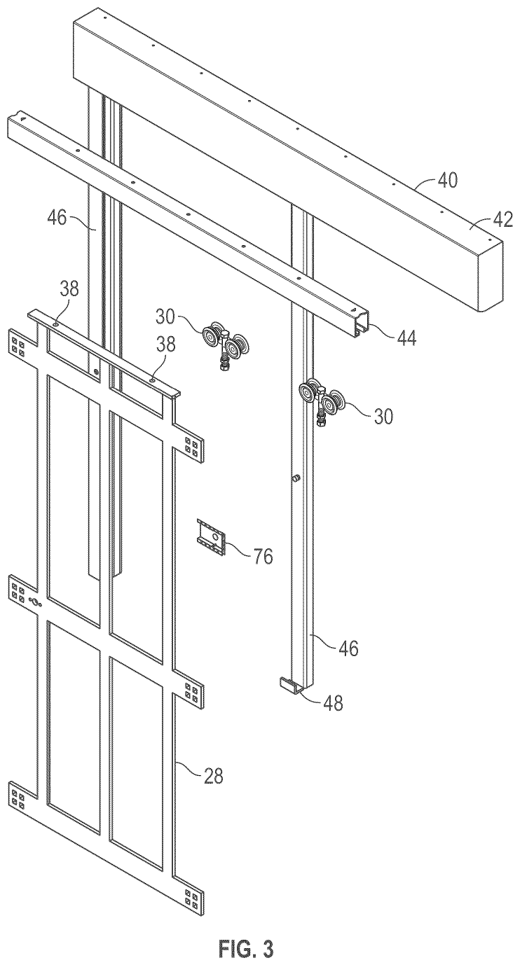

In some embodiments as best shown in FIGS. 1-4, the door or barricade 20 can include a bookshelf 22 (e.g., a plywood or other suitable material) having shelves 24 and vertical rails 26, a metal frame 28 and rollers 30 (e.g., metal, rubber, plastic, or other suitable material) connected to a bulletproof material backing 32 (e.g., bulletproof fiberglass or any other ballistic material). The door 20, when in the disengaged configuration, can sit on one side of a room's normal door opening 2, and when engaged, can lock into place in front of the room's opening 2. The rollers 30 in one embodiment may attach to the metal frame 28 of the door through holes 38 via bolts 36 and extend upwardly such that they ride upon a rail 44 or otherwise within the horizontal extension 42 of the frame 20.

In some embodiments, a bulletproof fiberglass panel 32 can be adhered, fastened, or otherwise coupled to the exterior side of the frame 28 of the door 20, while the interior may be built, in the case of a bookshelf, of ¾″ plywood (or composite). In many instances, the interior of the door (plywood/composite) is built into a bookshelf with a door handle, and will function as a bookshelf for the majority of its lifespan—needing only to be engaged in drills and real active shooter situations, although it should be known that any aesthetically pleasing and/or functional element may be attached to the interior of the barricade 20.

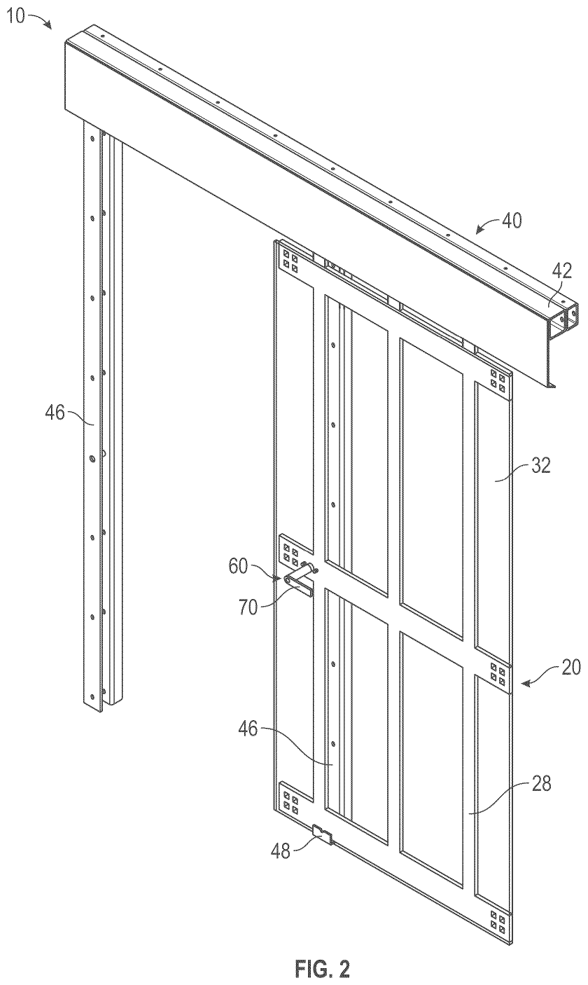

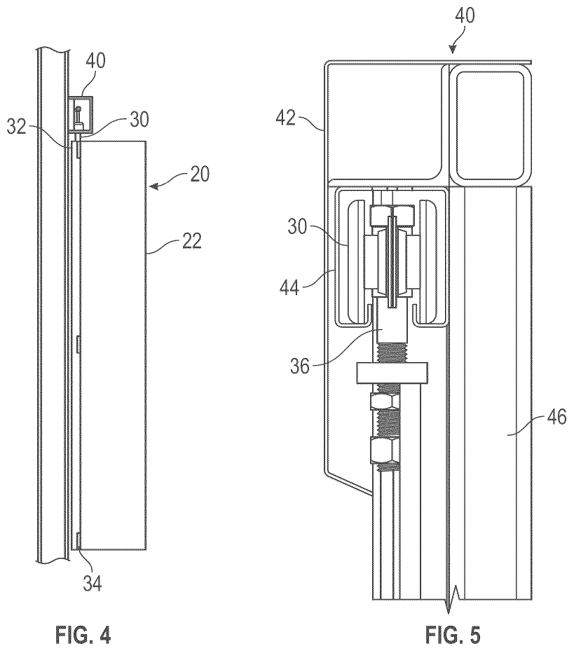

As best shown in FIG. 2, in some embodiments, the frame 40 may include a U-shaped guide 48 within which the door 20 can slide without leaning outwardly or inwardly keeping the door opening 2 closed by the door 20 when in use. In other embodiments, at the bottom of the door, there can be a groove 34 (as shown in FIG. 4) built in, within which the U-shaped guide 48 flange slides to ensure the door stays straight and cannot be pushed inward/outward and therefore cause the catch to miss the “D” pin. This can also assist in ensuring the threat cannot push the door inwardly when in the engaged position.

The door may be slidably coupled (e.g., via rollers 30) to a frame 40 that can be added to the current frame and surrounding walls around classroom doors (or the doors of other rooms like offices). In some embodiments, the frame 40 includes a horizontal rail or extension 42 and a pair of vertical uprights 46 can cover or surround the current frame of the doorway 2 and can have a horizontal extension 42 that reaches or extends from the current door frame 2 laterally on the wall into the room on one side of the door 2 or the other. This horizontal extension 42 as well as the top of the frame, holds a rail 44 upon which the door slides (e.g., within which the rollers 30 roll).

In some embodiments, the horizontal and vertical rails 42, 46 may be attached to the current door frame via bolts or lag screws. In other embodiments, where direct attachment to the existing door frame is unpracticable, the horizontal and vertical rails 42, 46 may be attached to the walls (e.g., to the studs within the walls or by some other attachment method).

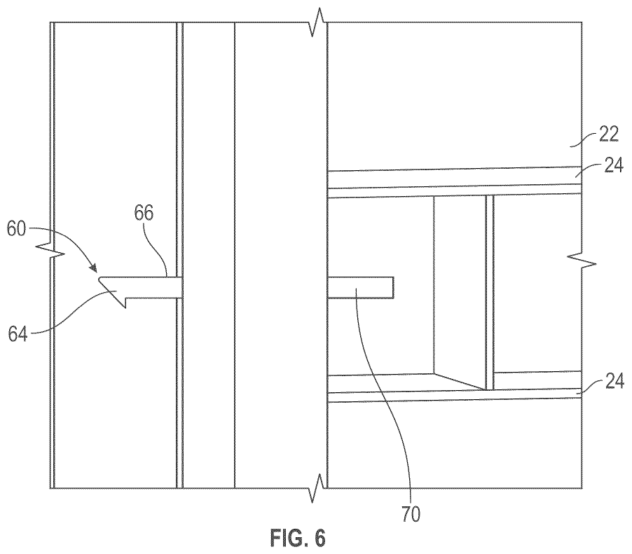

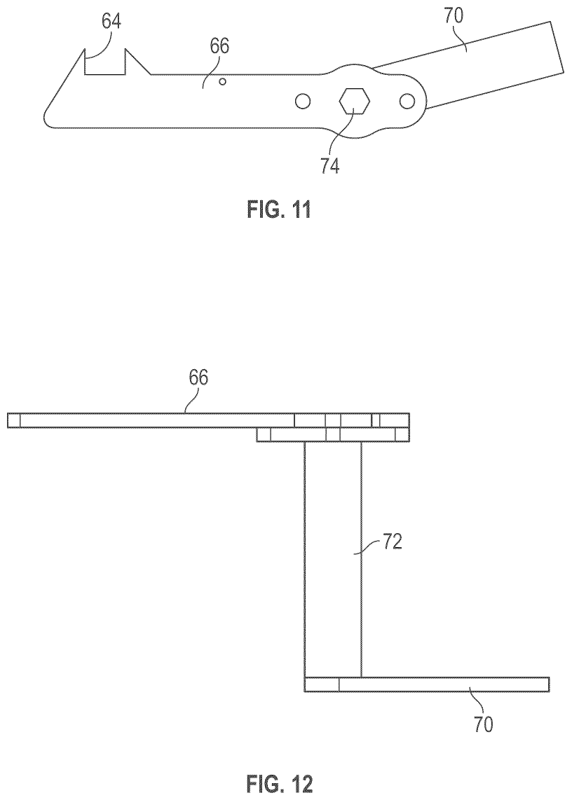

As shown in FIGS. 6-12, The door or barricade 20 may include a locking mechanism 60 that prevents an unauthorized person from gaining entrance into the room. Within the frame 40, on the vertical upright 46, there can be a “D” shaped pin 62, upon which a catch 64 of a locking lever 66 locks when engaged. In some embodiments, on the inside of the sliding door's frame 40 is a spring 68 that pulls (or pushes if connected above the lever 66) the catch 64 down into a locking position so that when engaged, a handle 70 coupled to the locking lever 66 is accessible only from the inside of the room and can push with enough upward force to rotate the locking mechanism 60 and disengage the lock.

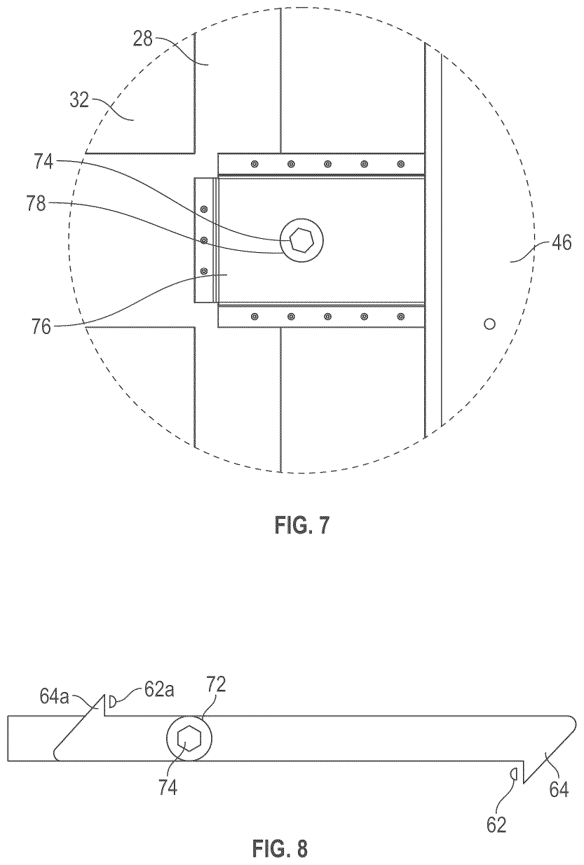

The handle may further comprise a pivot pin 72 that can go all the way through to the exterior side of the door, and can have a slot 74 in which an “L” shaped “key” can be placed to disengage from the hallway or exterior side of the door. The “key” may be hex shaped similar to locking mechanisms in schools already. As best shown in FIG. 7, the frame 28 may further include a lock cover 76 having a hole 78 through which the hex key may be inserted to turn the handle from the outside. The door system 10 may be sized, shaped and configured such that normal use of the current door is unaffected (i.e., the door is normally useable without restriction when the barricade door 20 is in the disengaged configuration, as well as being able to slide over and barricade the door when the current door is both open and closed.

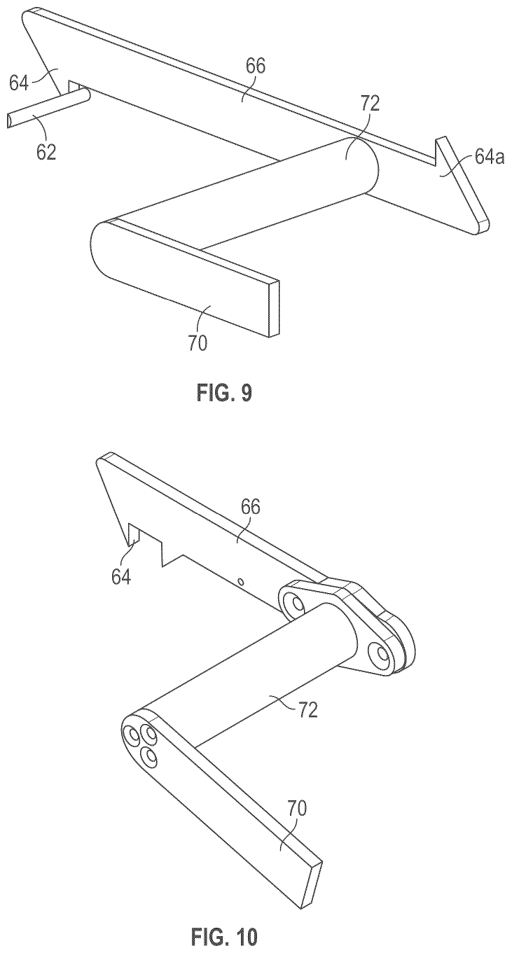

In some embodiments, as best shown in FIGS. 8-9, on the opposite end of the locking lever 66, is another catch system (D pin 62a) that locks the door into place when it is in a disengaged state (i.e., in it's standard position within the room and allowing entrance and egress to and from the room), so that when it is not being engaged as a barrier, it is not free sliding. The same downward pressure on the handle 70 from the interior can disengage this lock, which can allow the door to be slid into the engaged state (in its protective position in the current door opening 2 prevent entrance into the room). As shown in FIGS. 10-12, in other embodiments, there is only a single lever arm 66 and catch 64.

The weight of the door can vary. A sheet of plywood weighs about 61 pounds. In many instances, about a sheet and a half of plywood is used to build the wooden portion of the door, making the total wood weight around 100 lbs. The bulletproof fiberglass panel can weigh between 83.2 lbs. all the way to 480 lbs. depending upon the thickness (and therefore bullet resistance) desired. In some preferred examples, the panel weighs roughly 128.4 lbs. Metal pieces can also be included: a metal handle, metal brackets that hold the door to the rollers, etc.

Some examples have an advantage of not relying on any automation in the door. Automation can overcomplicate the device and require power, etc.—all of which could fail in the event of an active shooter situation. In some examples, a very simple, user-friendly door can be engaged by both teachers and young students but can also have a use/aesthetic purpose within the classroom when not functioning as a barrier device. That said, some examples may use a motor to automate the movement and remove any free sliding.

One of the important functionality issues with existing devices is the fact that they cannot be disengaged by law enforcement or emergency personnel when they are clearing a building. In many examples, the devices described herein can be disengaged very simply. Disengagement from the hallway can be done with the use of an “L” shaped hex key, similar to those used in doors already. Emergency responders can put the “L” shaped hex key into the door handle's pivot pin on the hallway side. The “L” key can then act as an exterior handle for the barrier and allow emergency responders to add upward force on the internal spring and allow for the handle catch to disengage from the “D” pin. At this point, the door would slide freely. In order for an active shooter to disengage the door, they would have to have inside knowledge enough to know about the “L” key, and have to have access to one of these keys or another similar key. They would also have to take the time to use the key, which goes against what the statistics would say the shooter would choose to do. Because they are looking for the highest body count in nearly every active shooter situation, they move beyond barricaded rooms if they are not able to quickly enter and enact carnage. In order to enter a room equipped with the system 10 described herein, the shooter would have to get through the room's normal door, and then attempt to shoot through or use an “L” key while holding a weapon. This would considerably slow them down and allow emergency responders time to act. Based on the statistics and information we have available about school shooters, we believe a shooter would see this device and simply move on, possibly after trying and failing to shoot through the device.

Existing devices utilize different functionality and are less effective. Some devices disengage the door to all, including emergency personnel. Its disengaging concept is foreign to both adults and children, so would be difficult for children in the room to disengage. It does not make the door bulletproof, and a strong hammer could disengage the product. Other “door disengaging” products exist, and all have similar weaknesses. Other systems create a bulletproof barricade. These are very expensive and they remove any option of fleeing the room out of the window. They also assume the shooter will enter the room, and are aesthetically displeasing, as they are a constant reminder to all in the room that there may be a shooter situation.

The device herein can be an alternative to bulletproof doors. Bulletproof doors are more expensive, and will still need to be barricaded in the event of an active shooter. The device described herein can function as both a bulletproof door and a barricade. Bulletproof doors also have a window, which allows line of sight, which our product removes.

Various locking mechanisms and rail systems can be used. For example, bookshelf/door can involve sliding system or a rack and pinion system to move between the open position and the closed position. In another example, the locking mechanism may include a vertical “stop” lever or other levers that engage/disengage with either the frame or the rollers/rack and pinion.

Operational Details of Example System: In an emergency, someone from inside the room operates the handle 70 of the locking mechanism to uncouple the locking mechanism from the D-pin on the frame 40 or on the wall of the room. The user then slides the door 20 into place, locking the locking mechanism 40 on the D-pin on the frame 40 securely to prevent entry, while still allowing exit from inside or entry by emergency responders via a special key mechanism.

Various examples have been described with reference to certain disclosed embodiments. The embodiments are presented for purposes of illustration and not limitation. One skilled in the art will appreciate that various changes, adaptations, and modifications can be made without departing from the scope of the invention.

What is claimed is:

1. A protective slidable barrier for a room comprising:
(A) a support frame comprising a horizontal rail extending along a top portion of an existing room door opening, the horizontal rail comprising a track;
(B) a sliding door comprising:
(i) a bulletproof back sheet;
(ii) a door frame having a plurality of rollers operably coupled with the horizontal rail; and
(iii) a latch operably configured to secure the sliding door in an open position or a closed position.

2. The protective slidable barrier of claim 1, wherein:
(i) in the open position, the sliding door is configured to be completely free of the existing room door opening; and
(ii) in the closed position, the sliding door is configured to completely cover the existing room door opening.

3. The protective slidable barrier of claim 1, wherein the sliding door further comprises a bookshelf coupled to the door frame on an opposite side from the bulletproof back sheet.

4. The protective slidable barrier of claim 1, wherein the support frame further comprises a pair of vertical uprights, each of the pair of vertical uprights affixed to either side of the existing room door opening and configured to support the horizontal rail.

5. The protective slidable barrier of claim 4, wherein each of the pair of vertical uprights are operably coupled to each of a pair of existing vertical uprights of the existing door room door opening.

6. The protective slidable barrier of claim 4, wherein each of the pair of vertical uprights comprises a catch pin.

7. The protective slidable barrier of claim 1, wherein the latch comprises a rotatable latch configured to operably engage a catch pin to secure the barrier in the closed position.

8. A protective slidable barrier for a room comprising:
(A) a support frame comprising a horizontal rail extending along a top portion of an existing room door opening, the horizontal rail comprising a track;
(B) a sliding door comprising:
(i) a door frame having a plurality of rollers operably coupled with the track; and
(ii) an armored back sheet coupled to the door frame; and
(C) a locking mechanism comprising:
(i) a catch pin;
(ii) a latch; and
(iii) a catch on one end of the latch and configured to operably engage the catch pin to hold the sliding door in a closed position.

9. The protective slidable barrier of claim 8, wherein the sliding door further comprises an open position, wherein the sliding door is configured to be completely free of the existing room door opening, and wherein the sliding door is configured to completely cover the existing room door opening when in the closed position.

10. The protective slidable barrier of claim 8, wherein the sliding door further comprises a bookshelf coupled to the door frame on an opposite side from the armored back sheet.

11. The protective slidable barrier of claim 8, wherein the support frame further comprises a pair of vertical uprights, each of the pair of vertical uprights affixed to either side of the existing room door opening and configured to support the horizontal rail.

12. The protective slidable barrier of claim 11, wherein each of the pair of vertical uprights are operably coupled to each of a pair of vertical uprights of a door frame of the existing room door opening.

13. The protective slidable barrier of claim 11, wherein the latch comprises a rotatable latch configured to operably engage the catch pin to secure the sliding door in the closed position.

14. A protective barrier system for a room comprising:
a support frame having a horizontal rail extending along a top portion of an existing room door opening, the horizontal rail comprising a track;
a sliding door having a door frame with a plurality of rollers operably coupled with the track, the sliding door further comprising an armored back sheet coupled to the door frame and a latch having a first catch on a first end configured to operably engage a D-pin to hold the sliding door in a closed position.

15. The protective barrier system of claim 14, wherein the support frame further comprises a pair of vertical uprights, each of the pair of vertical uprights affixed to either side of the existing room door opening and configured to support the horizontal rail.

16. The protective barrier system of claim 15, wherein the D-pin is disposed on one of the pair of vertical uprights.

17. The protective barrier system of claim 14, wherein the rotatable latch further comprises a second catch on a second end configured to operably engage a second D-pin to hold the sliding door in an open position.

18. The protective barrier system of claim 14, wherein the armored back sheet comprises a ballistic material.

19. The protective barrier system of claim 14, wherein the sliding door further comprises a bookshelf coupled to a front side of the door frame.

20. The protective barrier system of claim 14, wherein the support frame is operably coupled to a door frame of the existing room door opening.
